(19) United States
(12) Patent Application Publication
(10) Pub. No.: US 2013/0127999 A1
(43) Pub. Date: May 23, 2013

(54) CALIBRATION APPARATUS FOR VEHICLE MOUNTED CAMERA

(71) Applicant: Kiyoyuki KAWAI, Fukushima-ken (JP)

(72) Inventor: Kiyoyuki KAWAI, Fukushima-ken (JP)

(73) Assignee: Toshiba Alpine Automotive Technology Corporation, Iwaki-shi (JP)

(21) Appl. No.: 13/408,377

(22) Filed: Feb. 29, 2012

(30) Foreign Application Priority Data
Nov. 18, 2011 (JP) 2011-252570

(51) Int. Cl. H04N 17/00; H04N 13/02

(52) U.S. Cl. 348/47; 348/148; 348/E17.002; 348/E13.074

(57) ABSTRACT

According to one embodiment, an apparatus for calibrating a camera while a vehicle is moving includes a rearward monitoring camera mounted in a vehicle to acquire image information, a memory that stores a camera calibration program for computationally determining and calibrating mounting parameters of the camera while the vehicle is moving, using the image information acquired by the camera, a gear position detector to detect gear positions of the vehicle and generates position signals according to the gear positions and a control unit that receives the image information, and when the gear position detector detects a position signal for other than a reverse gear position, that reads out and executes the camera calibration program stored in the memory.

### CROSS-REFERENCE TO RELATED APPLICATION

This application is based upon and claims the benefit of priority from the prior art Japanese Patent Application No. 2011-252570 filed on Nov. 18, 2011, the entire contents of which are incorporated herein by reference.

### FIELD

Embodiments described herein relate generally to a calibration apparatus for a vehicle mounted camera that automatically operates for calibrating a rearward monitoring vehicle mounted camera while the vehicle is running.

### BACKGROUND

A technique for calibrating the mounted height and the rotary angle of a triaxially revolving vehicle mounted camera arranged at the rear side of an automobile has been proposed.

The prior art operates for calibration, which may be manual calibration or automatic calibration periodically using a timer. The calibration algorithm employs characteristic points or characteristic lines, preparing a known database of road marks and comparing characteristic points or characteristic lines of actual images.

However, the start of calibration may not be able to timely correspond to changes with time because calibration may be manual calibration or automatic calibration based on a preset period. For image processing and calibration of a monitoring camera to be realized simultaneously, a system capable of operating simultaneously for both of them is required. Such a system will entails a problem of raised cost.

### BRIEF DESCRIPTION OF THE DRAWINGS

FIG. 1 is a conceptual block diagram of the first embodiment of calibration apparatus for a vehicle mounted camera according to the present invention;

FIG. 2 is a flowchart illustrating the flow of a calibration process while a vehicle is running;

FIG. 3 is a conceptual block diagram of the second embodiment of calibration apparatus for a vehicle mounted camera according to the present invention; and

FIG. 4 is a flowchart illustrating the flow of a calibration process while a vehicle is running.

### DETAILED DESCRIPTION

According to one embodiment, a calibration apparatus for a vehicle mounted camera includes an apparatus for calibrating a camera while a vehicle is moving includes a rearward monitoring camera mounted in a vehicle to acquire image information, a memory that stores a camera calibration program for computationally determining and calibrating mounting parameters of the camera while the vehicle is moving, using the image information acquired by the camera, a gear position detector to detect gear positions of the vehicle and generates position signals according to the gear positions and a control unit that receives the image information, and when the gear position detector detects a position signal for other than a reverse gear position, that reads out and executes the camera calibration program stored in the memory.

Now, embodiments of the present invention will be described below by referring to the drawings. Note that, throughout the drawings, the same components are denoted by the same reference symbols and will not be described repeatedly.

### First Embodiment

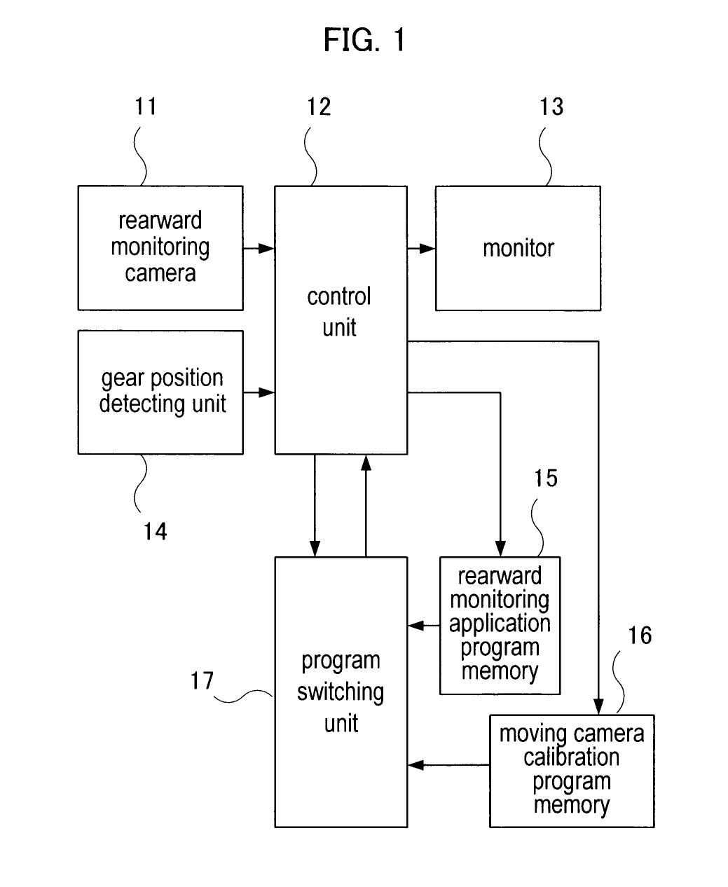

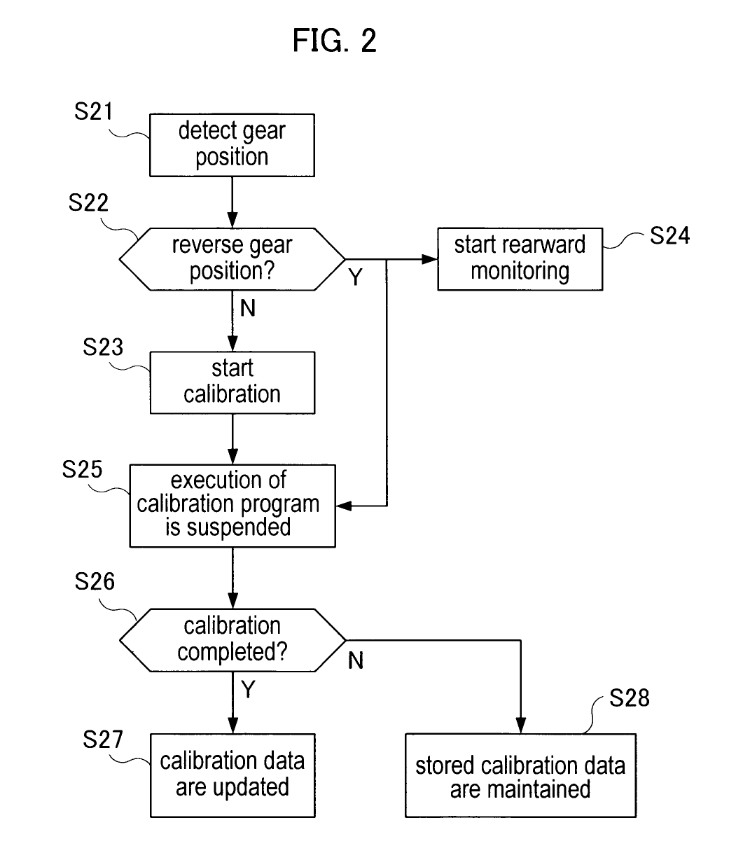

FIGS. 1 and 2 illustrate the first embodiment of calibration apparatus for a vehicle mounted camera according to the present invention. FIG. 1 is a conceptual block diagram and FIG. 2 is a flowchart illustrating the flow of a calibration process while a vehicle is running.

In a vehicle in which a vehicle mounted camera is mounted at the rear side of the vehicle, an operation of calibrating the vehicle mounted camera and correcting the errors from the set reference position (including the set height and the shooting angle) of the vehicle mounted camera is conducted by using an adjustment marker such as a camera calibration plate or the like at the time of manufacturing the vehicle. More specifically, an adjustment marker is displayed on a monitor screen and a plurality of markers that move on the screen according to operations of a joystick are also displayed on the screen. Then, information (mounting parameters also referred to as external programs hereinafter) on the set position (set height), the shooting angle and the horizontal angle of the optical axis of the vehicle mounted camera is acquired by making the coordinates of the plurality of markers correspond to the coordinates of the plurality of characteristic points of the adjustment marker in the real space. Note that the internal parameters including the focal length and the distortion characteristics of the vehicle mounted camera are out of the scope of moving camera calibration in this embodiment.

The obtained mounting parameters of the vehicle mounted camera are stored in a storage means such as a memory and utilized in subsequent calibration operations.

The vehicle mounted camera mounted in a vehicle is subject to changes with time in terms of the set height and the shooting angle that are initially set at the time of manufacturing the vehicle and calibrating the camera so that the shooting direction of the vehicle mounted camera may be unintentionally shifted.

Therefore, the calibration apparatus of this embodiment is designed to operate for calibration while the vehicle is running if any of the mounting parameters relating to the set state of the vehicle mounted camera that is calibrated at the time of manufacturing the vehicle have changed. However, it should be noted that calibration of the vehicle mounted camera frequently for all the mounting parameters requires a long processing time. Therefore, it may be preferable to select the shooting angle and the horizontal angle of the optical axis that are major parameters out of the number of parameters.

As shown in FIG. 1, the camera calibration apparatus of this embodiment includes as principal components a rearward monitoring camera 11, a control unit 12, a monitor 13, a gear position detecting unit 14, a rearward monitoring application program memory 15, a moving camera calibration program memory 16 and a program switching unit 17.

The rearward monitoring camera 11 is for monitoring the rearward of the vehicle. The rearward monitoring camera 11 may be a single camera or a stereo camera.

The monitor 13 displays the image picked up by the rearward monitoring camera 11. The monitor 13 may be so designed as to also display the image picked up by a frontward monitoring camera (not shown). While a calibration operation is in progress, a message telling that a calibration operation is in progress may preferably be displayed on the screen of the monitor 13.

The gear position detecting unit 14 detects the gear position of the vehicle and generates a gear position signal that corresponds to the current gear position, which is then supplied to the control unit 12.

The control unit 12 takes in the image signal of the image picked up by the rearward monitoring camera 11 and receives the gear position signal from the gear position detecting unit 14. The control unit 12 outputs a control signal for switching from the rearward monitoring application program to the moving camera calibration program or vice versa that is to be executed to process the image signal to the program switching unit 17. The control unit 12 may be formed as a CPU for example.

The rearward monitoring application program memory 15 is a memory for storing the rearward monitoring application program for processing the image signal of the rearward image picked up by the rearward monitoring camera 11. A data area for holding the data obtained during or after the execution of the program is secured in the memory 15. The rearward monitoring application program is executed under the control of the control unit 12 by way of the program switching unit 17.

The moving camera calibration program memory 16 is a memory for storing the moving camera calibration program. The moving camera calibration program computationally determines the mounting parameters of the rearward monitoring camera according to the image information acquired by the rearward monitoring camera and, if there is a shift in any of the parameter values from the time of initial installation, for example, calibrates the parameters. The moving camera calibration program is executed under the control of the control unit 12 by way of the program switching unit 17. The mounting parameters (calibration data) determined as a result of calibration are written in a rewriting operation in the moving camera calibration program memory 16 under the control of the control unit 12. The calibration data are reflected to the execution of the rearward monitoring application program after the calibration.

The program switching unit 17 selects either the rearward monitoring application program memory 15 or the moving camera calibration program memory 16 according to the program switching control signal it receives from the control unit 12.

A calibration technique that can feasibly be used while the vehicle is running may be adopted. For example, a known database of road marks (not shown) may be brought in and characteristic points or characteristic lines of actual images may be compared for calibration of external parameters. A stereo camera system may be used as monitoring camera to determine corresponding points between the cameras of the system and calibrate external parameters, utilizing that the corresponding points are found on the epipolar plane of the cameras.

Now, moving camera calibration as illustrated in FIG. 1 will be described further by referring to the flowchart of FIG. 2.

Firstly, in Step S21, the current gear position is detected by the gear position detecting unit 14 and a gear position signal of the vehicle is supplied to the control unit 12. If the current gear position is determined to be the reverse gear position in the next step, or Step S22, then the calibration operation proceeds to Step S24, where the rearward monitoring program stored in the rearward monitoring application program memory 15 is executed and a rearward monitoring operation is started.

If, on the other hand, the current gear position is determined to be not the reverse gear position in Step S22, the moving camera calibration program is executed in Step S23 and an operation of calibrating the mounting parameters of the rearward monitoring camera is started. For example, the mounting parameters during the manufacturing process and the current mounting parameters may be compared.

If the gear position is switched to the reverse gear position while the operation of calibrating the mounting parameters of the rearward monitoring camera is in progress, the execution of the moving camera calibration program is suspended (Step S25).

The moving camera calibration program is executed and if the calibration operation is completed or not is determined (Step S26). If it is determined that the calibration operation is completed, the calibration data are updated whenever necessary (Step S27). If, on the other hand, it is determined that the calibration operation is not completed, the stored last calibration data are maintained (Step S28).

With the above-described steps, a proper rearward monitoring operation is conducted by the rearward monitoring camera when the gear is at the reverse gear position, whereas an operation of constantly calibrating the external parameters is conducted when the gear is at a position other than the reverse gear position.

In the ordinary mode of utilization of a vehicle, the vehicle is driven forward for the most of the time and the ratio of the time spent to drive the vehicle to rearward is very small. Thus, while the mounting parameters of a vehicle mounted camera can fluctuate due to vibrations and changes with time particularly in terms of driving conditions, this embodiment can constantly update the mounting parameters.

Additionally, since the control unit 12 can commonly be used for both the rearward monitoring application program and the moving camera calibration program, which are switched from one to the other for execution by the program switching unit 17, so that this embodiment can be realized at lower cost.

Thus, this embodiment can operate for calibration while the vehicle is moving forward to accommodate the most current situation if the operating conditions of the rearward monitoring camera fluctuate.

As pointed out above, since a control unit can commonly be used for both the rearward monitoring application program and the moving camera calibration program, which are switched from one to the other for execution by the program switching unit, so that this embodiment can be realized at lower cost.

### Second Embodiment

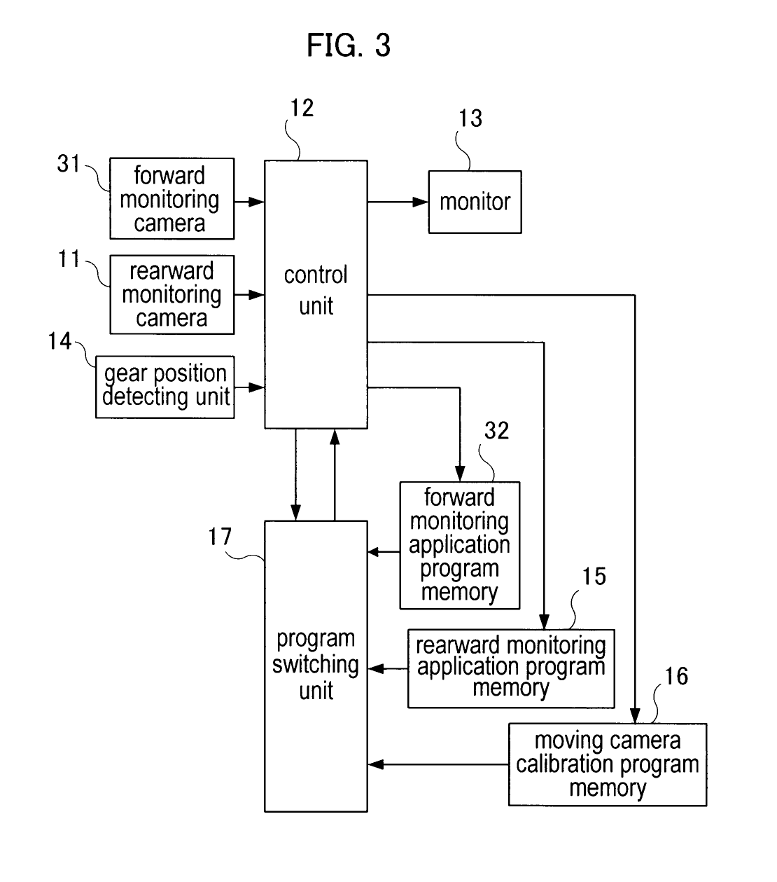

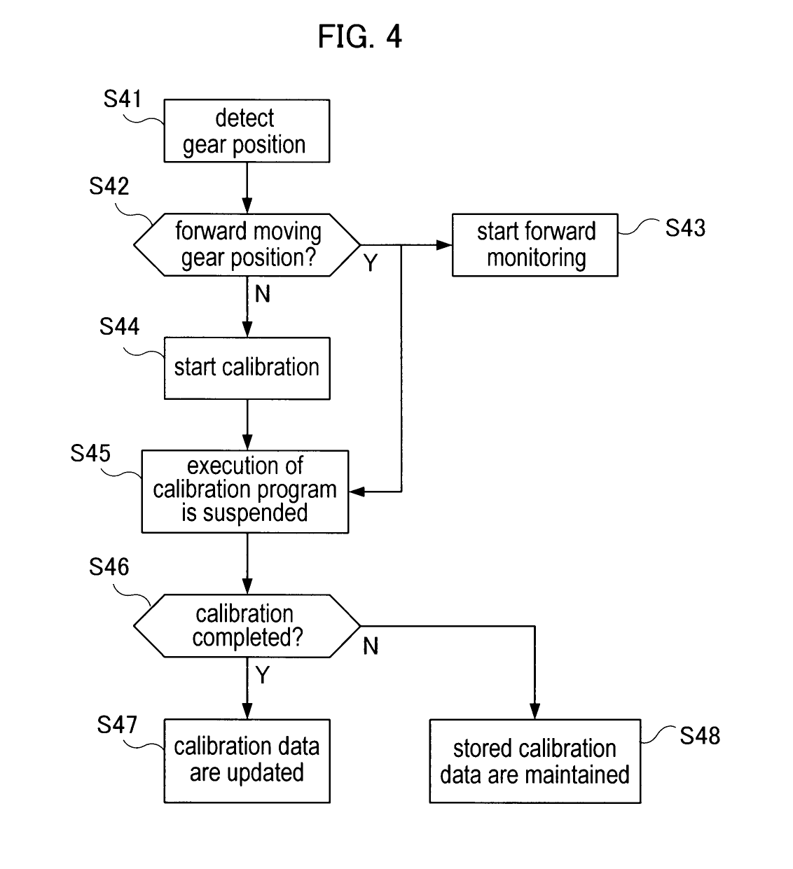

Now, the second embodiment of the present invention will be described below. FIGS. 3 and 4 illustrate the second embodiment of calibration apparatus for a vehicle mounted camera according to the present invention. FIG. 3 is a conceptual block diagram and FIG. 4 is a flowchart illustrating the flow of a calibration process while a vehicle is running.

The second embodiment has a functional feature of calibration of a forward monitoring camera when the vehicle in which the camera is mounted is moving rearward in addition to the functional feature of calibration of a rearward monitoring camera when the vehicle is moving forward.

As shown in FIG. 3, the calibration apparatus for a vehicle mounted camera of this embodiment includes as major components a rearward monitoring camera 11, a forward monitoring camera 31, a control unit 12, a monitor 13, a gear position detecting unit 14, a rearward monitoring application program memory 15, a moving camera calibration program memory 16, a forward monitoring application program memory 32 and a program switching unit 17.

The forward monitoring camera 31 is for monitoring the forward of the vehicle. The forward monitoring camera 31 may be a single camera or a stereo camera. The image signal of the image picked up by the forward monitoring camera 31 is supplied to the control unit 12.

The forward monitoring application program memory 32 is a memory for storing the forward monitoring application program. The forward monitoring application program is executed under the control of the control unit 12 by way of the program switching unit 17. The control unit 12 outputs a switching control signal to the program switching unit 17 in response to a gear position signal.

The program switching unit 17 selects one of the forward monitoring application program memory 32, the rearward monitoring application program memory 15 and the moving camera calibration program memory 17(16?) according to the control signal from the control unit 12.

In the second embodiment, an operation of calibrating the rearward monitoring camera 11 is conducted when the gear position detecting unit 14 detects a position signal for a forward moving gear position, whereas an operation of calibrating the forward monitoring camera 31 is conducted while the gear position detecting unit 14 detects a position signal for the reverse gear position. The calibration data obtained as a result of conducting a calibration operation are reflected to the execution of the forward monitoring application program or the rearward monitoring application program after the calibration.

Now, moving camera calibration of the forward monitoring camera 31 as illustrated in FIG. 3 will be described below by referring to the flowchart of FIG. 4. Note that moving camera calibration of the rearward monitoring camera 11 can be processed by following the flowchart of FIG. 2 in the above-described manner.

Firstly, the current gear position is detected by the gear position detecting unit 14 and a gear position signal of the vehicle is supplied to the control unit 12 (Step S41). Then, it is determined if the gear position is a forward moving gear position or not (Step S42). If the current gear position is determined to be a forward moving gear position, then the forward monitoring application program stored in the rearward monitoring application program memory 15 is executed to start a forward monitoring operation (Step S43).

If, on the other hand, the current gear position is determined to be not a forward moving gear position, that is, to be a reverse gear position, in Step S42, the moving camera calibration program is executed and an operation of calibrating the mounting parameters of the forward monitoring camera is started (Step S43). For example, the mounting parameters during the manufacturing process and the current mounting parameters may be compared.

If the gear position is switched to a forward moving gear position while the operation of calibrating the mounting parameters of the forward monitoring camera is in progress, the execution of the moving camera calibration program is suspended (Step S45).

The moving camera calibration program is executed and if the calibration operation is completed or not is determined (Step S46). If it is determined that the calibration operation is completed, the calibration data are updated whenever necessary (Step S47). If, on the other hand, it is determined that the calibration operation is not completed, the stored last calibration data are maintained (Step S48).

Note that the start of forward monitoring by the forward monitoring camera 31 in Step S43 may be made to take place also when the gear position is the neutral position.

Thus, the second embodiment operates for calibration of the rearward monitoring camera when the vehicle is running forward and for calibration of the forward monitoring camera when the vehicle is running rearward. Therefore, this embodiment can obtain image information that reflects the most updated situation such as fluctuations of the operating conditions of each of the monitoring cameras. Additionally, calibration operations can be realized only by adding a program at lower additional cost.

While certain embodiments have been described, these embodiments have been presented by way of example only, and are not intended to limit the scope of the inventions. Indeed, the novel methods and systems described herein may be embodied in a variety of the other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An apparatus for calibrating a camera while a vehicle is moving, comprising:
a rearward monitoring camera mounted in a vehicle to acquire image information;
a memory that stores a camera calibration program for computationally determining and calibrating mounting parameters of the camera while the vehicle is moving, using the image information acquired by the camera;
a gear position detector to detect gear positions of the vehicle and generates position signals according to the gear positions; and
a control unit that receives the image information, and when the gear position detector detects a position signal for other than a reverse gear position, that reads out and executes the camera calibration program stored in the memory.

2. The apparatus according to claim 1, wherein the camera is a single camera.

3. The apparatus according to claim 1, wherein the camera is a stereo camera.

4. The apparatus according to claim 1, further comprising:
a database storing data relating to known road displays on roads on which the vehicle runs, and wherein
the camera calibration program calibrates the mounting parameters by comparing the characteristic points or characteristic lines of the image information actually acquired by the camera with the data stored in the database.

5. The apparatus according to claim 1, wherein the mounting parameters are the set height and the shooting angle of the camera.

6. The apparatus according to claim 1, wherein the mounting parameters are the horizontal angle of the optical axis of the camera.

7. The apparatus according to claim 1, wherein the memory has a data area for holding the calibration data obtained during or after the execution of the camera calibration program.

8. The apparatus according to claim 3, wherein the camera calibration program is executed to determine the corresponding points between the cameras and calibrate the mounting parameters, utilizing that the corresponding points are found on the epipolar plane of the cameras.

9. A calibration apparatus for a vehicle mounted camera comprising:
a first camera for forward monitoring mounted in a vehicle;
a second camera for rearward monitoring mounted in the vehicle;
a memory that stores a moving camera calibration program for computationally determining and calibrating mounting parameters of the first camera according to image information acquired by the first camera and for computationally determining and calibrating mounting parameters of the second camera according to image information acquired by the second camera;
a gear position detecting unit that detects the gear position of the vehicle and generates a position signal according to the gear position; and
a control unit that receives the image information acquired by the second camera as input and reads out the moving camera calibration program stored in the memory to calibrate the second camera when the gear position detecting unit detects a position signal for a forward moving gear position; and
receives the image information acquired by the first camera as input and reads out the calibration program stored in the memory to calibrate the first camera when the gear position detecting unit detects a position signal for the reverse gear position.

10. The apparatus according to claim 9, wherein the first camera is a single camera.

11. The apparatus according to claim 9, wherein the first camera is a stereo camera.

12. The apparatus according to claim 9, further comprising:
a database for road displays on roads on which the vehicle runs, and wherein
the moving camera calibration program calibrates the mounting parameters by comparing the characteristic points or characteristic lines of the actual image acquired by the first camera or the second camera with the data in the database.

13. The apparatus according to claim 9, wherein the mounting parameters are the set height and the shooting angle of the first camera or the second camera.

14. The apparatus according to claim 9, wherein the mounting parameters are the horizontal angle of the optical axis of the first camera or the second camera.

15. The apparatus according to claim 9, wherein the memory has a data area for holding the calibration data obtained during or after the execution of the moving camera calibration program.

16. The apparatus according to claim 11, wherein the moving camera calibration program is executed to determine the corresponding points between the first cameras and calibrate the mounting parameters, utilizing that the corresponding points are found on the epipolar plane of the cameras.

17. The apparatus according to claim 11, wherein the moving camera calibration program is executed to determine the corresponding points between the second cameras and calibrate the mounting parameters, utilizing that the corresponding points are found on the epipolar plane of the cameras.
